(19) United States
(12) Patent Application Publication
(10) Pub. No.: US 2024/0428267 A1
(43) Pub. Date: Dec. 26, 2024

(54) METHODS AND INTERNET OF THINGS SYSTEMS FOR SUPERVISING SMART GAS CORPORATE USERS, AND MEDIA THEREOF

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN)

(73) Assignee: CHENGDU QINCHUAN IOT TECHNOLOGY CO., LTD., Chengdu (CN)

(21) Appl. No.: 18/823,957

(22) Filed: Sep. 4, 2024

(30) Foreign Application Priority Data
Jul. 9, 2024 (CN) 202410915263.9

(51) Int. Cl. G06Q 30/018

(52) U.S. Cl. CPC G06Q 30/018

(57) ABSTRACT

Embodiments of present disclosure provides a method and an Internet of Things (IoT) system for supervising a smart gas corporate user, and a medium thereof. The method includes determining a production phase and a production energy efficiency of a corporate user based on corporate user information, production status information, and current gas data; generating a gas supervision parameter based on the production phase and the production energy efficiency; sending the gas supervision parameter to a monitoring device; and monitoring gas data of the corporate user based on a data monitoring frequency and uploading the monitored gas data to a gas management platform at a data uploading frequency by the gas device object platform, and uploading the monitored gas data to a governmental supervision and management platform by the gas management platform.

### CROSS-REFERENCE TO RELATED APPLICATIONS

This application claims priority to Chinese Patent Application No. 202410915263.9, filed on Jul. 9, 2024, the entire contents of which are hereby incorporated by reference.

### TECHNICAL FIELD

The present disclosure relates to the field of Internet of Things (IoT) technology, and in particular, to methods and IoT systems for supervising smart gas corporate users, and media thereof.

### BACKGROUND

With the rapid development of city gas industry, to achieve the goal of energy saving and emission reduction, the government needs to regulate real-time data on energy efficiency and environmental protection of corporates to provide necessary data support for energy supply, corporate carbon emissions, and environmental protection. Gas usage, as an important source of carbon emissions, has become one of the key focus of regulation. However, gas usage varies among corporates at different stages, and adopting a fixed model of regulation may lead to insufficient regulation and data gaps during peak production periods, or excessive regulation and inefficiency during low peak production periods.

In response to the above problem, patent CN110134094B proposes an energy consumption monitoring and management system for industrial corporates based on an energy collection module, a cloud server, and a remote monitoring terminal. In this application, the energy collection module first collects energy consumption data of each industrial corporate, the cloud server then stores the energy consumption data, finally, the remote monitoring terminal perform online monitoring of the energy resource consumption status of each industrial corporate and perform online monitoring of electricity consumption safety. However, the application does not involve the automatic adjustment of the monitoring program according to the energy consumption of the corporates at different stages.

Therefore, it is desirable to provide a method and an Internet of Things (IoT) system for supervising a smart gas corporate user, and a medium thereof, which are capable of automatically adjusting the gas supervision parameter according to the actual gas consumption of the corporates, and improving the quality and efficiency of supervision.

### SUMMARY

In order to solve the problem of implementing personalized supervision for different corporates and improve the quality of supervision, the present disclosure provides a method and an Internet of Things (IoT) system for supervising a smart gas corporate user, and a medium thereof.

The content of the present disclosure comprises a method for supervising a smart gas corporate user. The method is executed by an Internet of Things (IoT) system for supervising a smart gas corporate user. The method includes obtaining corporate user information of a corporate user in a target area based on a data storage center of a gas management platform; obtaining production status information of the corporate user based on a governmental supervision and management platform; and obtaining current gas data of the corporate user at a preset time period base on a gas metering instrumentation of a gas device object platform; determining at least one of a production phase and a production energy efficiency of the corporate user based on the corporate user information, the production status information, and the current gas data; generating a gas supervision parameter based on the production phase and the production energy efficiency, the gas regulatory parameter including at least one of a data monitoring frequency and a data uploading frequency of a monitoring device for a current production phase; sending the gas supervision parameter to the monitoring device of the gas device object platform; and monitoring gas data of the corporate user based on the data monitoring frequency and uploading the monitored gas data to the gas management platform at the data uploading frequency by the gas equipment object platform, and uploading the monitored gas data to the governmental supervision and management platform by the gas management platform.

One of the embodiments of the present disclosure provides an Internet of Things (IoT) system for supervising a smart gas corporate user. The system includes a corporate user platform, a corporate user service platform, a gas management platform, a gas sensing network platform, and a gas device object platform interacting with each other. The IoT system is configured to obtain corporate user information of a corporate user in a target area based on a data storage center of the gas management platform; obtain production status information of the corporate user based on a governmental supervision and management platform; and obtain current gas data of the corporate user at a preset time period base on a gas metering instrumentation of the gas device object platform; determine at least one of a production phase and a production energy efficiency of the corporate user based on the corporate user information, the production status information, and the current gas data; generate a gas supervision parameter based on the production phase and the production energy efficiency, the gas regulatory parameter including at least one of a data monitoring frequency and a data uploading frequency, of a monitoring device for a current production phase; send the gas supervision parameter to the monitoring device of the gas device object platform; and monitor gas data of the corporate user based on the data monitoring frequency and upload the monitored gas data to the gas management platform at the frequency of data by the gas device object platform, and upload the monitored gas data to the governmental supervision and management platform by the gas management platform.

One or more embodiments of the present disclosure provide a non-transitory computer-readable storage medium storing computer instructions. When a computer reads the computer instructions in the storage medium, the computer performs the method for supervising the smart gas corporate user.

The present disclosure includes but is not limited to the following beneficial effects. Based on corporate user information, production status information, and current gas data, the gas supervision parameter is determined. Regulatory programs for different corporates may be adaptively generated, and the scope of application of the IoT system 100 may be improved, realizing targeted supervision, which is conducive to the effect of improving the quality of supervision.

### BRIEF DESCRIPTION OF THE DRAWINGS

The present disclosure will be further illustrated by way of exemplary embodiments, which are described in detail by means of the accompanying drawings. These embodiments are not limiting, and in these embodiments, the same numbering denotes the same structure, wherein:

FIG. 1 is a schematic diagram illustrating an exemplary Internet of Things (IoT) system for supervising a smart gas corporate user according to some embodiments of the present disclosure;

FIG. 2 is a flowchart illustrating an exemplary method for supervising a smart gas corporate user according to some embodiments of the present disclosure;

FIG. 3 is a flowchart illustrating an exemplary process for determining a production phase and a production effectiveness of a corporate user according to some embodiments of the present disclosure;

FIG. 4 is a schematic diagram illustrating a process for determining future gas data based on a gas usage model according to some embodiments of the present disclosure;

FIG. 5 is a flowchart illustrating an exemplary process for determining a gas supervision parameter according to some embodiments of the present disclosure; and

FIG. 6 is a schematic diagram illustrating a process for determining a gas anomaly user based on an analysis model according to some embodiments of the present disclosure.

### DETAILED DESCRIPTION

The accompanying drawings, which are to be used in the description of the embodiments, are briefly described below. The accompanying drawings do not represent the entirety of the embodiments.

As used herein, “system”, “device”, “unit” and/or “module” are used as means of distinguishing between different levels of components, elements, parts, sections, or assemblies. However, the words may be replaced by other expressions if other words would accomplish the same purpose.

Unless the context clearly suggests an exception, the words “a”, “an”, “one”, and/or “the” do not refer specifically to the singular, but may also include the plural. Generally, the terms “including” and “comprising” suggest the inclusion of explicitly identified steps and elements that do not constitute an exclusive list, and the method or apparatus may also include other steps or elements.

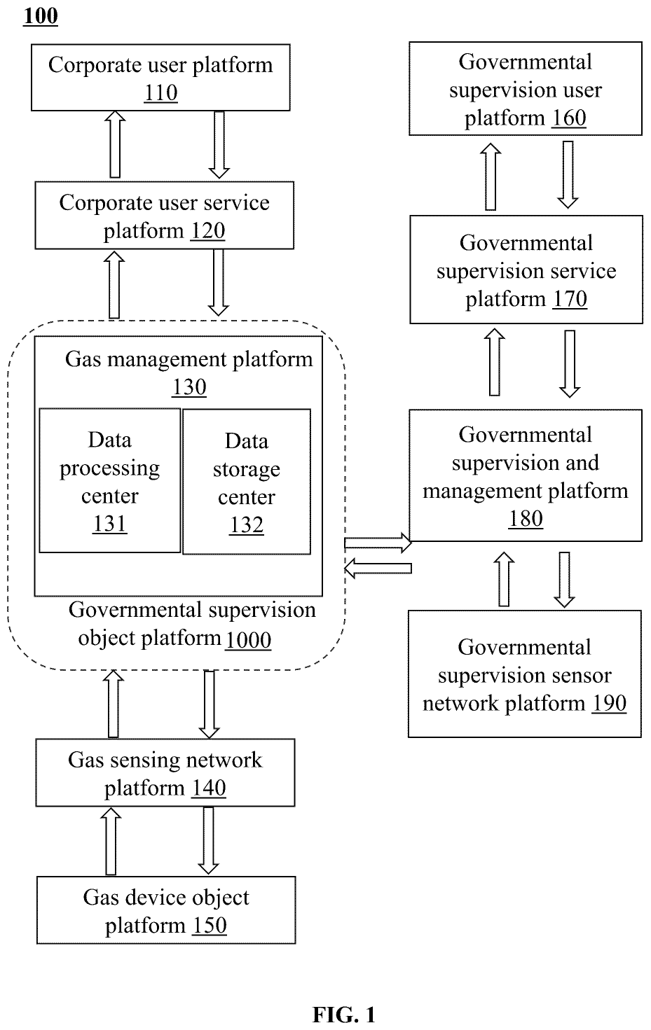

FIG. 1 is a schematic diagram illustrating an exemplary Internet of Things (IoT) system for supervising a smart gas corporate user according to some embodiments of the present disclosure. The IoT system for supervising the smart gas corporate user provided by the embodiments of the present disclosure will be described in detail below. It should be noted that the following embodiments are used only for explaining the present disclosure and do not constitute a limitation of the present disclosure.

In some embodiments, as shown in FIG. 1, an IoT system for supervising a smart gas corporate user 100 (referred to as system 100) includes a corporate user platform 110, a corporate user service platform 120, a gas management platform 130, a gas sensing network platform 140, and a gas device object platform 150 interacting with each other.

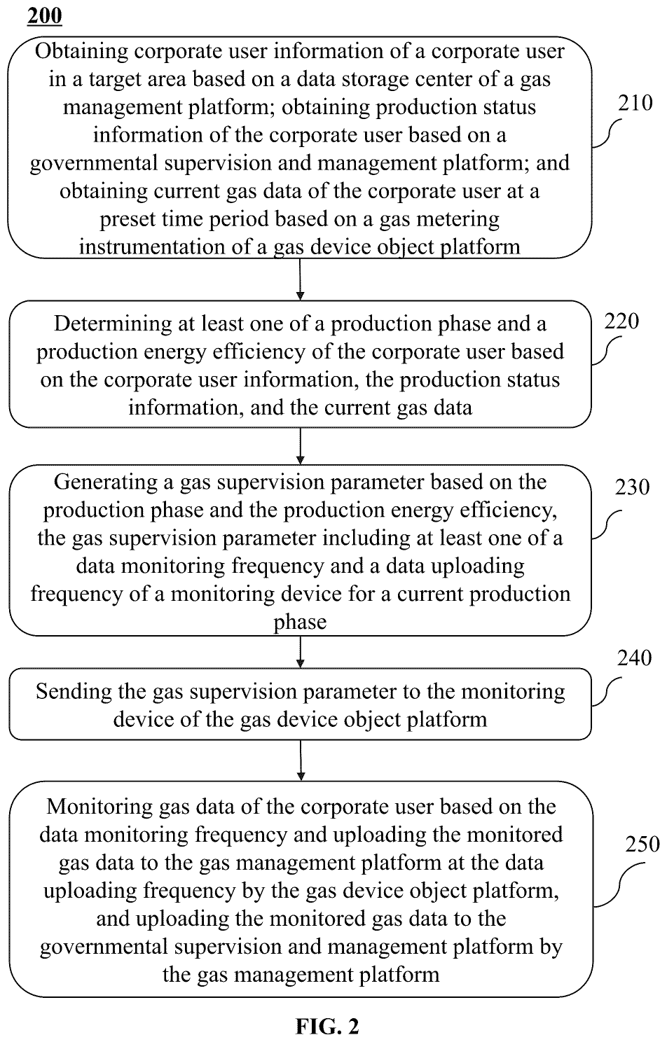

The corporate user platform 110 may be a platform for interacting with the corporate user. In some embodiments, the corporate user platform 110 may be configured as a terminal device. The corporate user refers to a corporate or a public institution that uses gas on the IoT system for supervising the smart gas corporate user. Further description regarding the corporate user may be found in FIG. 2 and related descriptions thereof. In some embodiments, the corporate user platform 110 may be referred to as a gas user platform.

The corporate user service platform 120 may be a platform for communicating information about needs and controls of the corporate user. The smart gas service platform 120 may obtain a gas supervision parameter, or the like, from the gas management platform 130 (e.g., a data processing center 131) and send the gas supervision parameter to the corporate user platform 110. In some embodiments, the corporate user service platform 120 may be referred to as a gas user service platform.

The gas management platform 130 may be a platform that integrates and coordinates the communication and collaboration between functional platforms and aggregates all of the information of the IoT to provide sensing management and control management functions for the IoT operating system. In some embodiments, the gas management platform 130 may be referred to as a gas company management platform.

In some embodiments, the gas management platform 130 may include a data processing center 131 and a data storage center 132.

The data processing center 131 may be configured to process data related to the IoT system 100. For example, the data processing center 131 may generate the gas supervision parameter based on a production phase and a production energy efficiency. Further description regarding generating the gas supervision parameter may be found in FIG. 2 and related descriptions thereof.

In some embodiments, the data storage center 132 may be configured to store data and/or instructions related to the IoT system 100. For example, the data storage center 132 may store corporate user information for a corporate user in a target area. In some embodiments, the data storage center 132 may exchange information with the corporate user service platform 120 and the gas sensing network platform 140, respectively. As another example, the data storage center 132 may send the gas supervision parameter to the corporate user service platform 120. As yet another example, the data storage center 132 may send an instruction to the gas sensing network platform 140 to obtain current gas data and/or historical gas data.

The gas sensing network platform 140 may be a functional platform that manages sensing communications. In some embodiments, the smart gas sensing network platform 140 may realize sensing communications for sensing information and sensing communications for controlling information. In some embodiments, the gas sensing network platform 140 may be referred to as a gas company sensing network platform.

In some embodiments, the smart gas sensing network platform 140 may be configured to interact with the gas management platform 130 and the gas device object platform 150.

The gas device object platform 150 may be a functional platform for generating the sensing information and executing the controlling information. For example, the smart gas object platform 150 may monitor and generate the current gas data, the historical gas data, or the like. In some embodiments, the gas device object platform 150 may be configured as a monitoring device.

The monitoring device refers to a device that is configured to collect, record, and upload gas data. In some embodiments, the monitoring device may monitor the gas data of the corporate user and upload the monitored gas data to the gas management platform 130, which in turn is uploaded by the gas management platform 130 to the governmental supervision and management platform 180.

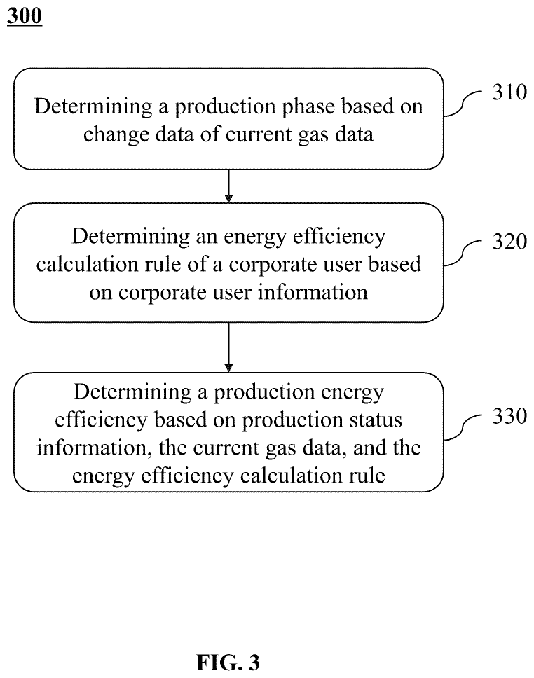

The monitoring device may include an exhaust gas monitoring device. Related descriptions of the exhaust gas monitoring device may be found in FIG. 3 and its related descriptions.

In some embodiments, the IoT system 100 may further include a governmental supervision user platform 160, a governmental supervision service platform 170, a governmental supervision and management platform 180, a governmental supervision sensor network platform 190, and a governmental supervision object platform 1000 interacting with each other in sequence. In some embodiments, the governmental supervision user platform 160 may be referred to as a people user platform. In some embodiments, the gas management platform 130 may obtain production status information of the corporate user based on the governmental supervision and management platform 180.

In some embodiments, the gas management platform 130 may interact bi-directionally with the governmental supervision sensor network platform 190.

In some embodiments of the present disclosure, the IoT system 100 may form a closed loop of information operation between the gas device object platform 150 and the corporate user platform 110, and operate under the unified management of the data processing center 131 in the gas management platform 130 in a coordinated and regular manner, realizing the digitalization and intelligence of supervision of the smart gas corporate user.

FIG. 2 is a flowchart illustrating an exemplary method for supervising a smart gas corporate user according to some embodiments of the present disclosure. As shown in FIG. 2, process 200 includes the following steps. In some embodiments, the process 200 may be performed by the IoT system 100.

Step 210, corporate user information of a corporate user in a target area is obtained based on a data storage center of a gas management platform; production status information of the corporate user is obtained based on a governmental supervision and management platform; and current gas data of the corporate user at a preset time period is obtained based on a gas metering instrumentation of a gas device object platform. In some embodiments, the step 210 may be performed by the gas management platform 130.

The target area refers to an area where a gas supervision parameter needs to be generated. For example, the target area may be a street, a city, a province, or the like. In some embodiments, the gas management platform 130 may obtain the target area in a plurality of ways, for example, at least one of obtaining based on historical data or obtaining user input.

The corporate user refers to a corporate or a public institution that uses gas in the target area. In some embodiments, the corporate user may be one or a plurality of users. In some embodiments, the gas management platform 130 may obtain the corporate user in a plurality of ways, for example, at least one of obtaining based on historical data or obtaining user input.

The corporate user information refers to information related to the corporate user. In some embodiments, the corporate user information may include at least one of a corporate classification, a type of gas usage equipment, the number of gas usage equipment, or the like. In some embodiments, the gas management platform 130 may obtain the corporate user information of the corporate user in the target area based on the data storage center of the gas management platform 130.

The production status information refers to relevant information that may characterize a size of a corporate. In some embodiments, the production status information may include at least one of the number of employees of the corporate, a scale of production device of the corporate, a production value of the corporate, an output of the corporate, or the like. In some embodiments, the gas management platform 130 may obtain the production status information of the corporate user based on the governmental supervision and management platform 180.

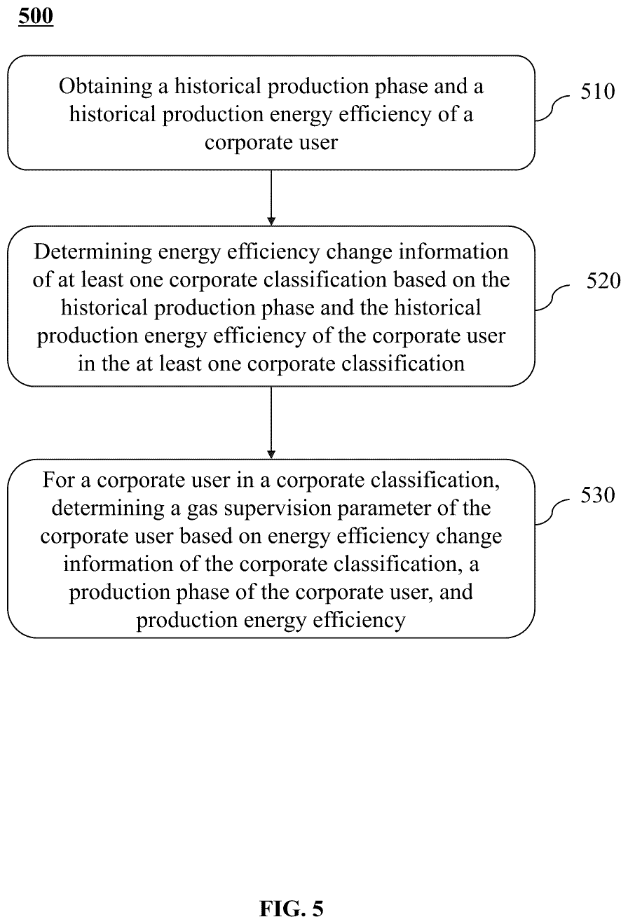

The preset time period refers to a time period used to assess the gas usage of the corporate, for example, at least one of the past 3 days, the past week, etc. In some embodiments, the preset time period may be determined in a plurality of ways. For example, the preset time period may be determined based on at least one of experience, historical data, actual need, etc. In some embodiments, the preset time period may also be set based on the gas supervision parameter. For example, the gas management platform 130 may set a reference data volume based on experience (e.g., processor performance, etc.), calculate a length of time required for a monitored gas usage data volume to reach a reference data volume based on the gas supervision parameter, and use the length of time as the preset time period. more descriptions regarding the gas supervision parameter may be found in step 230 and the related description of FIG. 5.

The gas data refers to data related to the usage of gas of the corporate user. In some embodiments, the gas data may include at least one of a gas usage time, the number of appliances using gas, a gas consumption rate, and a total gas usage over a certain time period. The current gas data refers to gas data of the corporate user during the preset time period. In some embodiments, the gas management platform 130 may obtain the current gas data of the corporate user in the preset time period based on the gas metering instrumentation of the gas device object platform 150.

Step 220, at least one of a production phase and a production energy efficiency of the corporate user is determined based on the corporate user information, the production status information, and the current gas data. In some embodiments, step 220 may be performed by the gas management platform 130.

The production phase refers to a phase that characterize the production and business conditions of the corporate user, such as peaks and valleys of production. In some embodiments, the production phase may be determined based on changes in the current gas data. For example, the production phase of the corporate user enters a peak phase if the total gas usage gradually rises during at least one production phase. As another example, the peak phase of production ends and the production phase of the corporate user enters a trough if the total gas usage gradually decreases during at least one production phase.

The production energy efficiency refers to the benefit that results from the usage of gas during the production of the corporate user. In some embodiments, the production energy efficiency may include at least one of an output or a production value generated per unit of gas usage. In some embodiments, the production energy efficiency may also include the number of employees and the number of production device that may be supported to perform the production per unit of gas production.

Some other descriptions regarding determining the production phase based on the change data of the current gas data and determining the production energy efficiency based on the production status information, the current gas data, and the energy efficiency calculation rules, may be found in FIG. 3 and related descriptions thereof.

Step 230, the gas supervision parameter is generated based on the production phase and the production energy efficiency. In some embodiments, step 230 may be performed by the gas management platform 130.

The gas supervision parameter refers to a parameter related to regulating the gas data for the current production phase. In some embodiments, the gas supervision parameter may include at least one of a data monitoring frequency or a data uploading frequency of the monitoring device for the current production phase. The current production phase refers to a production phase at the current moment. In some embodiments, there may be one or more sets of gas supervision parameters. When there is only one corporate user in the target area, there may be one set of gas supervision parameters. When there are a plurality of corporate users in the target area, there may be a plurality of sets of gas supervision parameters.

The data monitoring frequency refers to the number of times that the monitoring device is required to collect data per unit of time during the current production phase. In some embodiments, the gas management platform 130 may determine the data monitoring frequency in a variety of ways. For example, the data monitoring frequency is increased during peak production periods of the corporate to ensure the integrity of data monitoring.

The data uploading frequency refers to the number of times that the monitoring device is required to upload data per unit of time during the current production phase. In some embodiments, the gas management platform 130 may determine the data uploading frequency in a variety of ways. For example, the data uploading frequency to the governmental supervision user platform 160 is increased when the production energy efficiency of the corporate is low. A low production energy efficiency means that the production energy efficiency is lower than a production energy efficiency threshold. The production energy efficiency threshold may be determined based on at least one of experience or historical data.

Some other descriptions regarding determining the gas supervision parameter of the corporate user based on the energy efficiency change information in the corporate classification, the production phase of the corporate user, and the production energy efficiency of the corporate user may be found in FIG. 5 and related descriptions thereof.

Step 240, the gas supervision parameter is sent to the monitoring device of the gas device object platform. In some embodiments, step 240 may be performed by the gas management platform 130.

The monitoring device refers to a device that may be configured to monitor the gas data, e.g., at least one of a sensor or a flow meter. More descriptions regarding the monitoring devices may be found in FIG. 1 and related descriptions thereof.

In some embodiments, the gas device object platform 150 may be communicatively connected with the gas management platform 130, and the gas management platform 130 may send the gas supervision parameter to the monitoring device of the gas device object platform 150 to control the monitoring device to perform corresponding actions or functions.

Step 250, the gas data of the corporate user is monitored based on the data monitoring frequency and the monitored gas data is uploaded to the gas management platform at the data uploading frequency by the gas device object platform, and the monitored gas data is uploaded to the governmental supervision and management platform by the gas management platform. In some embodiments, step 250 may be performed by the gas device object platform 150.

In some embodiments, monitoring the gas data of the corporate user may include at least one of detecting the pressure of the gas using a pressure sensor or detecting the flow rate of the gas using a flow meter.

In some embodiments of the present disclosure, based on the corporate user information, production status information, and the current gas data, the gas supervision parameter is determined. Regulatory programs for different corporates may be adaptively generated, and the scope of application of the IoT system 100 may be improved, realizing targeted supervision, which is conducive to the effect of improving the quality of supervision.

FIG. 3 is a flowchart illustrating an exemplary process for determining a production phase and a production effectiveness of a corporate user according to some embodiments of the present disclosure. As shown in FIG. 3, process 300 includes the following steps. In some embodiments, the process 300 may be performed by the IoT system 100. In some embodiments, process 300 may be performed by the gas management platform 130.

Step 310, the production phase is determined based on change data of current gas data.

The change data of the current gas data refers to data that reflect changes in the current gas data. Descriptions regarding the current gas data may be found in FIG. 2 and related descriptions thereof.

In some embodiments, characteristics of the change data of the current gas data may include a direction of change, a rate of change, and a trend of change of the current gas data.

The gas management platform 130 may plot a curve of change of the current gas data based on current gas data corresponding to different time points and compute a first-order derivative and a second-order derivative of the curve of change of the current gas data.

In some embodiments, the gas management platform 130 may determine the direction of change of the current gas data based on a positive or negative first-order derivative. For example, the positive first-order derivative indicates that the current gas data may increase, and the negative derivative indicates that the current gas data may decrease. In some embodiments, the gas management platform 130 may determine the rate of change of the current gas data based on a value of the first-order derivative. For example, the gas management platform 130 may determine the rate of change of the current gas data based on the value of the first-order derivative.

In some embodiments, the gas management platform 130 may determine the trend of change of the current gas data based on a positive or negative first-order derivative and a positive or negative second-order derivative. For example, when the first-order derivative is positive and the second-order derivative is positive, the current gas data may gradually increase, and an increasing trend is getting larger. As another example, when the first-order derivative is positive and the second-order derivative is negative, the current gas data may gradually increase but the increasing trend is getting smaller, or the like.

The production phase may include peak and trough periods. In some embodiments, the peak production period of the production phase may further include a peak climb phase, a peak decline phase. The trough period may further include a trough entry phase, a production recovery phase. More descriptions regarding the production phase may be found in FIG. 2 and related descriptions thereof.

In some embodiments, when in the peak climb phase, the first-order derivative is positive, which corresponds to the direction of change of the current gas data as an increase; the first-order derivative gradually tends to 0, which corresponds to the rate of change of the current gas data tends to 0; the first-order derivative is positive and the second-order derivative is negative, which corresponds to the trend of change of the current gas data as a gradual increase but the increasing trend is getting smaller. If the change data of the current gas data satisfies that the direction of change of the current gas data is increasing, the rate of change tends to 0, and the trend of change is gradually increasing but the increasing trend is becoming smaller, then the gas management platform 130 may determine that the production phase is the peak climb phase.

In some embodiments, when in the peak decline phase, the first-order derivative is negative, which corresponds to the direction of change of the current gas data as a decrease; the first-order derivative is negative, and the second-order derivative is negative and gradually tends to 0, which corresponds to the trend of the current gas data as a gradual decrease but the increasing trend is getting smaller. If the change data of the current gas data satisfies that the direction of change of the current gas data is decreasing, and the trend of change is gradually decreasing and the decreasing trend is getting smaller, the gas management platform 130 may determine that the production phase is the peak decline phase.

In some embodiments, when in the trough entry phase, the first-order derivative is negative, which corresponds to the direction of change of the current gas data as a decrease; the first-order derivative gradually tends to 0, which corresponds to the rate of change of the current gas data as tending to 0; the first-order derivative is negative and the second-order derivative is positive, which corresponds to the trend of the current gas data as a gradual decrease, but the decreasing trend is getting larger. If the change data of the current gas data satisfies that the direction of change of the current gas data is decreasing, the rate of change tends to 0, and the trend of change is decreasing but the decreasing trend is getting larger, the gas management platform 130 may determine that the production phase is the trough entry phase.

In some embodiments, when in the production recovery phase, the first-order derivative is positive, which corresponds to the direction of change of the current gas data as an increase; the first-order derivative is positive, and the second-order derivative is positive and gradually tends to 0, which corresponds to the trend of change of the current gas data as a gradual increase. If the change data of the current gas data satisfies that the direction of change of the current gas data is increasing, and the trend of the change is gradually increasing and the increasing trend is getting larger, the gas management platform 130 may determine that the production phase is the production recovery phase.

Understandably, since the current gas data is the gas data during the preset time period, if the preset time period spans two phases (e.g., the trough entry phase and the production recovery phase), the change data of the current gas data may satisfy the characteristics of the two phases. In this case, the last phase (e.g., the production recovery phase) may be designated as the production phase.

In some embodiments, the gas management platform 130 may also determine the production phase based on gas usage change data, usage duration change data, and the current gas data. For example, the gas management platform 130 may predict future gas data based on the current gas usage change data, the usage duration change data, and the current gas data, then plot a gas profile based on the current gas data and the future gas data, and finally determine the production phase based on the gas profile.

The change data of the current gas data may include the gas usage change data and the usage duration change data.

The gas usage change data refers to data that reflects changes in gas usage. The content and acquisition of the gas usage change data are the same as the content and acquisition of the above change data and may not be repeated here.

The usage duration change data refers to data that reflects changes in the length of time that the corporate user uses gas in a day. The acquisition of the usage duration change data is similar to the acquisition of the change data described above and is not repeated here.

Determining the future gas data requires consideration of the gas usage change data and the usage duration change data since changes in both gas usage and usage duration may have influenced the future gas data.

The future gas data refers to the current gas data for a predicted future time period. In some embodiments, the gas management platform 130 may determine the future gas data based on the gas usage change data, the usage duration change data, and the current gas data. For example, the gas management platform 130 may construct gas data vectors based on the gas usage change data, the usage duration change data, and the current gas data, and determine the future gas data based on search results of the gas data vectors in the vector database. The vector database includes a plurality of reference vectors and the future gas data for a second historical time period after a first historical time period corresponding to each reference vector. The reference vector is constructed based on the gas usage change data, the usage duration change data, and the current gas data for the first historical time period in the historical data. A gas management center may select the future gas data corresponding to the reference vector with the smallest vector distance as the future gas data by calculating a vector distance between the gas data vector and the reference vector.

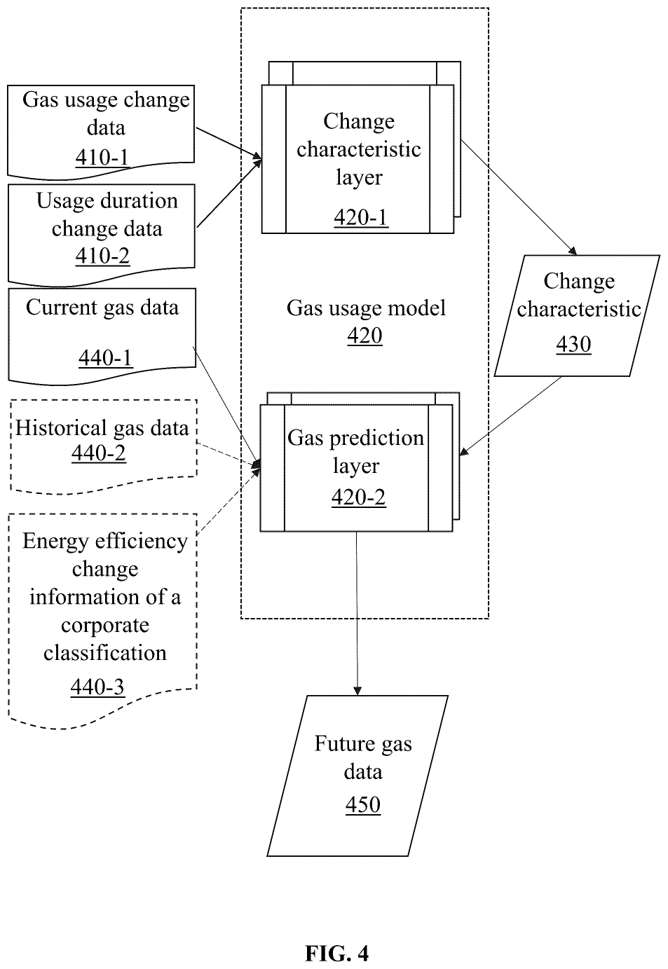

More descriptions regarding predicting the future gas data based on the gas usage change data, the usage duration change data, and the current gas data may be found in FIG. 4 and related descriptions thereof.

In some embodiments, the gas management platform 130 may plot the gas profile based on the current gas data and the future gas data. The gas profile refers to a graph reflecting the direction of change, the rate of change, the trend of change, etc., of the current gas data and the future gas data.

The method for determining the production phase based on the gas profile is the same as the method for determining the production phase based on the curve of changes in the current gas data and is not described herein.

In some embodiments of the present disclosure, the gas management platform 130, by plotting the gas profile, may clearly observe the changes in the gas data and may further determine the production phase based on the gas profile, which helps to predict in more detail the gas usage of the corporate at different time periods.

Step 320, an energy efficiency calculation rule of the corporate user is determined based on the corporate user information.

The energy efficiency calculation rule refers to a rule for different corporate classifications to calculate the production energy efficiency. For example, the energy efficiency calculation rule may include calculating an energy efficiency by a production value, calculating the energy efficiency by an output, calculating the energy efficiency by an equipment consumption, or the like. In some embodiments, for different corporate classifications, the gas management platform 130 may obtain the corporate classification and the energy efficiency calculation rule based on a content of the corporate's production, a production manner, the gas usage, a reported production, a shipment volume, and the production value, or the like, by checking a preset table. The preset table may be set by a government user in the IoT. More detailed descriptions regarding the production energy efficiency may be found in FIG. 2 and related descriptions thereof.

Step 330, the production energy efficiency is determined based on the production status information, the current gas data, and the energy efficiency calculation rule.

In some embodiments, the data processing center 131 may determine the production energy efficiency based on the production status information, the current gas data, and the energy efficiency calculation rules. For example, based on corporate user information of corporate A, the data processing center determines that the energy efficiency calculation rule of the corporate is to calculate the energy efficiency by a production (i.e., a production generated by gas consumption per unit is designated as the production energy efficiency), then the gas management center may calculate the production generated by the gas consumption per unit based on the corporate's production in the production status information, and a gas consumption rate in the current gas data, so as to obtain the production energy efficiency. Specific descriptions regarding the production status information and the current gas data may be found in FIG. 2 and related descriptions thereof.

In some embodiments, the monitoring device includes an exhaust gas monitoring device. The exhaust gas monitoring device refers to a flowmeter that monitors a specific component of an exhaust gas produced by combustion of the gas. For example, the specific component may be sulphur dioxide, methane, or the like.

In some embodiments, the gas management platform 130 may determine the production energy efficiency by performing steps 331-335.

Step 331, an initial production energy efficiency is calculated based on the production status information and the current gas data by the energy efficiency calculation rule.

In some embodiments, the gas management center may calculate to determine the initial production energy efficiency based on the production status information and the current gas data according to the energy efficiency calculation rule. The process of determining the initial production energy efficiency is the same as the process of determining the production energy efficiency as described above and may not be repeated herein.

Step 332, the exhaust gas monitoring device of the gas device object platform 150 is determined based on historical energy efficiency data of the corporate user.

The historical energy efficiency data refers to energy efficiency data for a historical time period. In some embodiments, the gas management platform 130 may obtain the historical energy efficiency data from a data storage center.

In some embodiments, the gas management platform 130 may select a different exhaust gas detection device based on a historical production effectiveness of the corporate user. For example, for a corporate user with a high historical production energy efficiency, conventional sensors (carbon dioxide sensors, etc.) may be used for monitoring; for a corporate user with a low historical production energy efficiency, more comprehensive sensors (methane sensors, carbon monoxide sensors, etc.) may be used to obtain more detailed gas content data.

Step 333, exhaust gas data of the corporate user is obtained based on the exhaust gas monitoring device.

The exhaust gas data refers to data of a content of various gaseous components in the exhaust gas, for example, the exhaust gas data may be data of the content of methane, sulfur dioxide, carbon monoxide, carbon dioxide, water vapor, and other components in the exhaust gas. In some embodiments, the exhaust gas data may be detected by the exhaust gas monitoring device.

Step 334, a combustion adequacy of the corporate user is determined based on the exhaust gas data.

The combustion adequacy refers to an adequacy of gas combustion. In some embodiments, the combustion adequacy is related to the exhaust gas data. For example, the combustion adequacy may be obtained by calculating a ratio of reference exhaust gas data to the exhaust gas data. The reference exhaust gas data refers to exhaust gas data when the gas is sufficiently combusted in a manually predetermined ideal state.

Step 335, the production energy efficiency is determined based on the combustion adequacy and the initial production energy efficiency.

In some embodiments, the production energy efficiency is determined by the gas management platform 130 based on the combustion adequacy and the initial production energy efficiency. In some embodiments, the production energy efficiency is positively correlated with the combustion adequacy. For example, the gas management platform 130 may determine the production energy efficiency based on a product of the combustion adequacy and the initial production energy efficiency. More descriptions regarding determining the production energy efficiency may be found in FIG. 2 and related descriptions thereof.

In some embodiments of the present disclosure, by obtaining the exhaust gas data by the exhaust gas monitoring device while evaluating the production energy efficiency of the corporate user in combination with energy efficiency calculation rules of different types of corporates, the production energy efficiency of the corporate may be more accurately determined.

In some embodiments of the present disclosure, based on the change data of the current gas data, the production phase, the production status information, the current gas data, and the energy efficiency calculation rule are determined, and the production energy efficiency of the corporate user is also determined, which contributes to more accurately understanding the corporate's energy utilization and making decisions more scientifically.

FIG. 4 is a schematic diagram illustrating a process for determining future gas data based on a gas usage model according to some embodiments of the present disclosure.

In some embodiments, a gas management platform 130 may determine future gas data 450 based on gas usage change data 410-1, usage duration change data 410-2, and current gas data 440-1 through a gas usage model 420.

As shown in FIG. 4, the gas usage model 420 includes a change characteristic layer 420-1 and a gas prediction layer 420-2. The change characteristic layer 420-1 and the gas prediction layer 420-2 may be machine learning models. For example, the change characteristic layer 420-1 may be a long short-term memory (LSTM) model and the gas prediction layer 420-2 may be a recurrent neural network (RNN) model.

In some embodiments, an input of the change characteristic layer 420-1 may include the gas usage change data 410-1 and the usage duration change data 410-2, and an output of the change characteristic layer 420-1 may include a change characteristic 430. For example, the gas usage change data 410-1 may be [a, b, c], where a represents a direction of gas usage change, b represents a rate of gas usage change, and c represents a trend of gas usage change. The usage duration change data 410-2 may be [d, e, f], where d represents a direction of usage duration change, e represents a rate of the usage duration change, and f represents a trend of the usage duration change.

The change characteristic 430 refers to a characteristic used to characterize changes in gas usage over time by the corporate user.

In some embodiments, an input of the gas prediction layer 420-2 may include the current gas data 440-1 and the change characteristic 430 of the change characteristic layer 420-1, and an output of the gas prediction layer 420-2 may include future gas usage data 450. For example, the current gas data 440-1 may be [g, h, i, j], where g represents a time of gas usage during a preset time period, h represents the number of appliances using gas during the preset time period, i represents a rate of gas consumption during the preset time period, and j represents a total gas usage during the preset time period. For example, the current gas data 440-1 may be [g, h, i, j], where g represents a time of gas usage during the preset time period, h represents the number of appliances using gas during the preset time period, i represents the rate of gas consumption during the preset time period, and j represents the total gas usage during the preset time period.

Descriptions regarding the current gas data may be found in FIG. 2 and related descriptions thereof. Descriptions regarding the gas usage change data, the usage duration change data, and the future gas data may be found in FIG. 3 and related descriptions thereof.

In some embodiments, the input of the gas prediction layer may also include historical gas data 440-2 and energy efficiency change information 440-3 of a corporate classification. Descriptions regarding the historical gas data may be found in FIG. 2 and related descriptions thereof. For example, the historical gas data 440-2 may be [k, l, m, n], where k represents a time of the gas usage during a historical time period, 1 represents the number of appliances using gas during the historical time period, m represents a rate of gas consumption during the historical time period, and n represents a total gas usage during the historical time period.

The energy efficiency change information 440-3 of the corporate classification may be

$$[ \begin{matrix}( b - a ) & ( e - d ) \\ ( c - b ) & ( f - e )\end{matrix} ] ,$$

where the production energy efficiency of the corporate classification to which the corporate user belongs for three consecutive years in the peak production period is a, b, and c, respectively, the production energy efficiency for three consecutive years in the trough period is d, e, and f, respectively, and then the energy efficiency change information is a sequence, with a first column of the energy efficiency change in the peak production period, and a second column of the energy efficiency change in the trough period.

The energy efficiency change information 440-3 of the corporate classification refers to changes in the production energy efficiency of corporates of different corporate classifications. More descriptions regarding the energy efficiency change information may be found in FIG. 5 and related descriptions thereof.

The gas management platform 130 may predict, combined with the current gas data, the changes in the current gas data compared to the historical time period based on the analysis of the historical gas data over a certain time period. In addition, the production energy efficiency of the corporate classification is negatively correlated with a future gas usage of the corporate, and exemplarily, the higher the energy efficiency of the corporate classification, the lower the future gas usage of the corporate for the same production task.

In some embodiments of the present disclosure, the accuracy of prediction results of the gas prediction layer may be improved by using the historical gas data and the energy efficiency change information of the corporate classification as the input of the gas prediction layer.

In some embodiments, the gas usage model 420 may be obtained by training based on a plurality of first training samples with a first label. Training algorithms may include, but are not limited to, a gradient descent algorithm, or the like.

In some embodiments, the output of the change characteristic layer 420-1 may be the input of the gas prediction layer 420-2, and the change characteristic layer 420-1 and the gas prediction layer 420-2 may be jointly trained by the plurality of first training samples with the first label.

In some embodiments, the first training samples of the joint training may include sample gas usage change data, sample usage duration change data, and sample current gas data of a first historical time period in the historical data. The first label may be gas data for a second historical time period after the first historical time period of the first training samples.

In some embodiments, proportions of first historical time periods with different time scales in the first training samples are not less than a predetermined proportion. A time scale refers to a duration of the first historical time period. For example, if the first training samples are sample gas usage change data, sample usage duration change data, and sample current gas data from the past one month, the time scale of the first historical time period is one month. The predetermined proportion may be a system default value, an empirical value, a human pre-set value, or any combination thereof and may be set according to the actual demand, which is not limited in the present disclosure. The setting of the proportion helps to improve the adaptability of the gas usage model to input various types of time scale and improves a generalization ability of the gas usage model.

In some embodiments, the gas management platform 130 inputs the sample gas usage change data and the sample usage duration change data for the first historical time period in the historical data into an initial change characteristic layer to obtain sample change characteristics output from the initial change characteristic layer. The sample change characteristics, along with the sample current gas data, are input into the initial gas prediction layer as sample training data to obtain the future gas data output from the initial gas prediction layer. A loss function is constructed based on the first label and the future gas data output from the initial gas prediction layer, and parameters of the initial change characteristic layer and the initial gas prediction layer are updated based on the loss function.

In some embodiments, the parameters of the initial change characteristic layer and the initial gas prediction layer may be iteratively updated based on the plurality of first training samples to cause the loss function to satisfy a predetermined condition. For example, the predetermined condition may include that the loss function converges, or a value of the loss function is less than a predetermined value. The model training is completed when the loss function satisfies the predetermined condition, and the trained initial change characteristic layer and the trained initial gas prediction layer may be designated as the change characteristic layer and the gas prediction layer.

In some embodiments, the first training sample may further include historical gas data for a third historical time period before the first historical time period, and/or the energy efficiency change information of the corporate classification for the first historical time period.

In some embodiments of the present disclosure, the gas management platform 130 may reduce the number of samples required by jointly training the change characteristic layer and the gas prediction layer, solve the difficulty in obtaining the labeled change characteristics when training the change characteristic layer alone, and improve the training efficiency. In practical applications, the gas management platform 130 may quickly determine more realistic future gas data based on the trained gas usage model, further improving the accuracy of the prediction of the future gas data to meet the operation needs of the corporate.

FIG. 5 is a flowchart illustrating an exemplary process for determining a gas supervision parameter according to some embodiments of the present disclosure. As shown in FIG. 5, process 500 includes the following steps. In some embodiments, the process 500 may be performed by the IoT system 100. In some embodiments, the process 500 may be performed by the gas management platform 130.

Step 510, a historical production phase and a historical production energy efficiency of a corporate user is obtained.

The historical production phase refers to a production phase that has occurred. In some embodiments, the gas management platform 130 may obtain the historical production phase in a plurality of ways. For example, the gas management platform 130 may create a historical database, and the historical database may include the historical production phase of the corporate user. The gas management platform 130 may obtain the historical production phase from the historical database. In some embodiments, the historical database may be stored in the data storage center 132. More descriptions regarding the production phase may be found in the FIG. 2 and related descriptions thereof.

The historical production energy efficiency refers to the production energy efficiency that has occurred. In some embodiments, the historical database may also include the historical production energy efficiency of the corporate user. The gas management platform 130 may obtain the historical production energy efficiency from the historical database. More descriptions regarding the production energy efficiency may be found in FIG. 2 and related descriptions thereof.

Step 520, energy efficiency change information of at least one corporate classification is determined based on historical production phase and historical production energy efficiency of a corporate user in the at least one corporate classification.

The corporate classification refers to a category formed by categorizing the corporate user, e.g., a first category of corporates, a second category of corporates, or the like. In some embodiments, the gas management platform 130 may determine the corporate classification by categorizing the corporate user in a variety of categorization manners, e.g., categorization based on products of the corporate, categorization based on a size of the corporate, or at least one of the above.

The energy efficiency change information may reflect changes in energy for a corporate classification. For example, an increase in the production energy efficiency for a corporate classification may characterize that the corporate classification may use new technology to reduce energy loss, change the type of energy required, expand production conditions leading to energy utilization improvement, or the like.

The energy efficiency change information refers to information that may reflect a change in the production energy efficiency by the corporate user. In some embodiments, the energy efficiency change information may be a specific value or sequence. In some embodiments, the gas management platform 130 may calculate the energy efficiency change information based on a predetermined algorithm. For example, the production energy efficiency for each production phase of the corporate user for consecutive years is obtained, and a difference in the production energy efficiency corresponding to each production phase between two adjacent years is calculated. Differences in production energy efficiency are arranged in chronological order to form a sequence.

Exemplarily, the production energy efficiency of corporate A for three consecutive years in the peak production period is a, b, and c, respectively, and the production energy efficiency for three consecutive years in the trough period is d, e, and f, respectively, thus the energy efficiency change information is the sequence

$$[ \begin{matrix}( b - a ) & ( e - d ) \\ ( c - b ) & ( f - e )\end{matrix} ] ,$$

where the first column is the change in energy efficiency in the peak production period, and the second column is the change in energy efficiency in the trough period.

The energy efficiency change information for the corporate classification may be an average of the energy efficiency change information for each corporate user under the same corporate classification.

In some embodiments, the gas management platform 130 may calculate the energy efficiency change information based on a predetermined algorithm. For example, the gas management platform 130 obtains, from historical data, the production energy efficiency for each production phase for several consecutive years in each respective corporate user of at least one corporate classification. The energy efficiency change information for each corporate user is calculated, an average of the energy efficiency change information for each corporate user is calculated, and the energy efficiency change information for the corporate classification is obtained.

In some embodiments, determining the energy efficiency change information for the at least one corporate classification may include, for a corporate classification, determining the energy efficiency change information of the corporate classification based on the energy efficiency change information of the historical production energy efficiency for the corporate user in the corporate classification, through a weighting calculation.

For example, the energy efficiency change information of the corporate classification=(weight 1×energy efficiency change information of a first corporate user+weight2×energy efficiency change information of a second corporate user+. . .+weight n×energy efficiency change information of a nth corporate user)/n. Where n may be the number of corporate users.

In some embodiments, the weight of the weighting calculation may be correlated to a duration of each production phase of the corporate user in the corporate classification. For example, the weight may be positively correlated to a duration of the peak production period. Because the longer the peak production period, the more representative the corporate user is in that the corporate classification. The longer the duration of the peak production period, the greater the weight.

In some embodiments, the corporate user in the corporate classification may be ranked by gradient according to the duration of the peak production period, and weight may be assigned according to a gradient ranking. The higher the ranking, the higher the weight of the corporate user. The process of ranking by gradient may be that rank the duration of the peak production period or the interval of the duration of the peak production period in descending order.

The energy efficiency change information is determined by the weighting calculation, which improves the correlation between the duration of various production phases of the corporate user in the corporate classification and a value of energy efficiency change, which is conducive to the improvement of the accuracy of the energy efficiency change information.

In some embodiments, the weight also correlates to the combustion adequacy of the corporate user in the corporate classification.

The combustion adequacy refers to a degree of gas combustion. The combustion adequacy characterizes a utilization rate of gas. The higher the combustion adequacy of the corporate user, the higher the utilization rate of gas, the less gas is wasted, and the more representative the corporate user. More descriptions regarding the combustion adequacy may be found in FIG. 3 and related descriptions thereof.

In some embodiments, the corporate user in the corporate classification may be ranked by gradient based on the combustion adequacy, and the weight may be assigned based on the gradient ranking, and the higher the ranking of the corporate user, the higher the weight. The process of ranking by gradient may be that rank the combustion adequacy or a combustion adequacy interval in descending order.

In some embodiments, the corporate user in the corporate classification may be ranked comprehensively by gradient based on the combustion adequacy and the duration of the peak production period, and the weight may be assigned according to the gradient ranking. The higher the ranking, the higher the weight of the corporate user.

Based on the energy efficiency change information, the energy efficiency change information is determined by weighting calculation, which improves the correlation between the combustion adequacy and the energy efficiency change information and is conducive to the improvement of the accuracy of the energy efficiency change information.

Step 530, for a corporate user in a corporate classification, a gas supervision parameter of the corporate user is determined based on the energy efficiency change information of the corporate classification, the production phase of the corporate user, and the production energy efficiency. More descriptions regarding the gas supervision parameter may be found in FIG. 2 and related descriptions thereof.

In some embodiments, the gas management platform 130 may calculate the energy efficiency change information of the corporate based on the production energy efficiency of the corporate user and the historical production energy efficiency. For example, the gas management platform 130 may compare the energy efficiency change information of the corporate user, with the energy efficiency change information of the corporate classification in which the corporate user is located. For a corporate user whose energy efficiency change information is lower than the energy efficiency change information of the corporate classification, a data monitoring frequency and a data uploading frequency in the corresponding gas supervision parameter may be increased.

In some embodiments, the process of the gas management platform 130 generating the gas supervision parameter based on the production phase and the production energy efficiency, may further include determining a gas anomaly user based on at least one of the energy efficiency change information of at least one corporate classification, the production phase, and the production energy efficiency.

The gas anomaly user refers to a corporate user with anomalous gas data. In some embodiments, the gas anomaly user may include a corporate user with an anomaly in at least one of a time of gas usage, the number of appliances using gas, a rate of gas consumption, a total gas usage, etc.

In some embodiments, the gas management platform 130 may determine the gas anomaly user based on a predetermined algorithm. For example, the gas management platform 130 may obtain the time at which the current production phase is located and the time at which the historical corresponding production phase is located, calculate a time gap, and designate a corporate user with a time gap greater than or equal to a time gap threshold as the gas anomaly user. The time gap threshold may be obtained based on at least one of experience, historical data, or the like. Exemplarily, a corporate whose peak production period is delayed by 2 months from the peak production period of previous years is designated as the gas anomaly user.

As another example, the gas management platform 130 may calculate a theoretical production energy efficiency based on the historical production energy efficiency of the corporate user. A production energy efficiency difference between the production energy efficiency of a current production phase and the theoretical production energy efficiency is calculated, the corporate user with the production energy efficiency difference greater than or equal to a production energy efficiency difference threshold may be designated as the gas anomaly user. The theoretical production energy efficiency may be an average of the historical production energy efficiency. The production energy efficiency difference may be obtained based on at least one of experience, historical data, or the like.

More descriptions regarding the gas data may be found in FIG. 2 and related descriptions thereof.

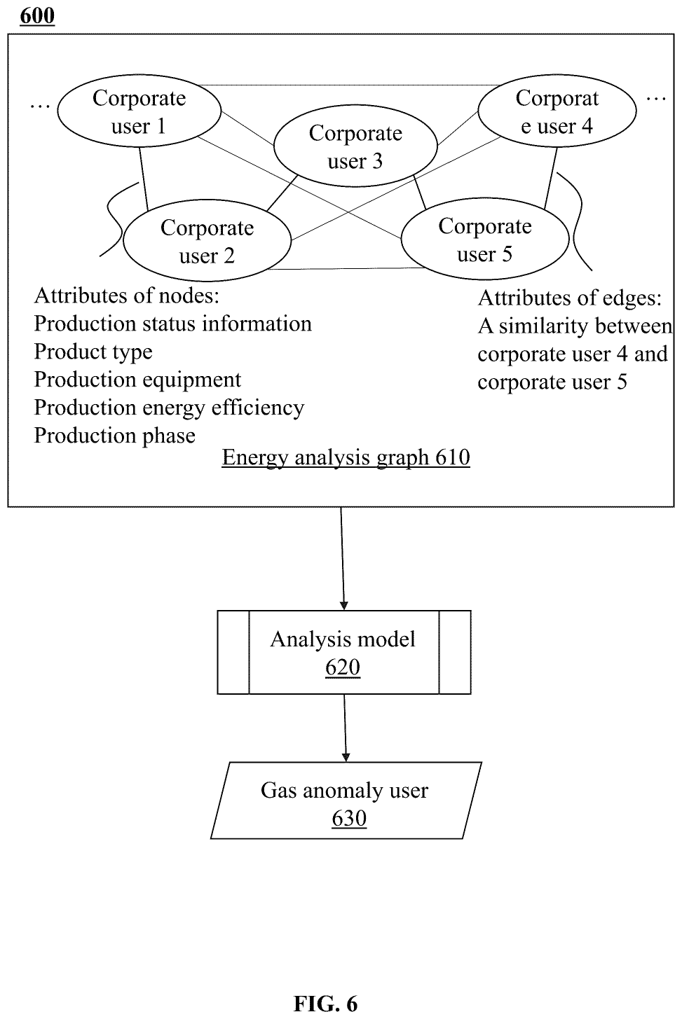

Some other embodiments of inputting an energy analysis graph into an analysis model to determine the gas anomaly user may be found in FIG. 6 and related descriptions thereof.

The gas supervision parameter of the gas anomaly user is adjusted to obtain an adjusted gas supervision parameter. In some embodiments, the gas management platform 130 may increase the data monitoring frequency and the data uploading frequency in the gas supervision parameter of the gas anomaly user.

By determining the gas anomaly user, the gas supervision parameter may be adjusted specifically to achieve accurate supervision.

In some embodiments of the present disclosure, based on energy efficiency change information of different corporate users, supervision parameters of different corporate users may be determined specifically to realize a precise control of each corporate user and improve the control precision of the IoT system 100.

In some embodiments, the process of determining the gas anomaly user includes, for a corporate classification, constructing an energy analysis graph 610 based on the corporate user in the corporate classification, the production phase, and the production energy efficiency, and inputting the energy analysis graph 610 into an analysis model 620 to determine a gas anomaly user 630. The analysis model 620 is a machine learning model. The energy analysis graph 610 includes nodes and edges, and the nodes include the corporate user. Attributes of the nodes include production status information, a product type, a production device, the production energy efficiency, and the production phase of the corporate user. The edges include a connecting line between any two nodes, and attributes of the edges include a similarity between two corporate users corresponding to the edges.

The energy analysis graph 610 refers to an undirected graph used to represent correlations of corporate users. The energy analysis graph 610 may include a plurality of the corporate users, as well as other features.

The energy analysis graph 610 may include the nodes and the edges.

In some embodiments, the nodes may include the corporate user. For example, the nodes may include a corporate user 1, a corporate user 2, a corporate user 3, a corporate user 4, a corporate user 5, or the like, as shown in FIG. 6.

In some embodiments, the attributes of the nodes may include the production status information of the corporate user, the product type, the production device, the production energy efficiency, and the production phase. The product type refers to a type of product produced by the corporate user. The production device refers to equipment that the corporate user produces the product with. More descriptions regarding the production status information, the production energy efficiency, and the production phase may be found in FIG. 2 and related descriptions thereof.

In some embodiments, the edges may be undirected. In some embodiments, the edges include the connecting line between any two of the nodes.

In some embodiments, the attribute of the edge includes a similarity of the two corporate users to which the edge corresponds, e.g., a similarity of the corporates in terms of the product type, the production device, or the like.

In some embodiments, the gas management platform 130 may construct an energy analysis graph 610 based on data related to the corporate user.

The analysis model 620 is a model used to determine the gas anomaly user 630. The analysis model 620 may be a machine learning model, e.g., a graph neural network (GNN), etc.

In some embodiments, an input of the analysis model 620 may be the energy analysis graph 610, and an output of the analysis model 620 may be the gas anomaly user 630. In some embodiments, the analysis model 620 may output an anomaly attribute for each node. For example, a node corresponding to the gas anomaly user has an anomaly attribute of 1 and the other nodes have an anomaly attribute of 0.

In some embodiments, the analysis model may be obtained by training based on a plurality of second training samples with a second label. The plurality of second training samples with the second label may be input into an initial analysis model, a loss function is constructed based on the second label and results of the initial analysis model, and parameters of the initial analysis model are iteratively updated based on the loss function. The model training is completed when the loss function of the initial analysis model satisfies a predetermined condition, and a trained analysis model is obtained. The predetermined condition may be that the loss function converges, the number of iterations reaches a threshold, etc.

In some embodiments, the second training samples may be sample energy analysis graphs constructed based on information about the corporate user and production status, the product type, the production device, the production energy efficiency, and the production phase in the historical data. The second label may be an actual gas anomaly user in the historical data.

Using the analysis model to identify the gas anomaly user may improve the accuracy and efficiency of determining the gas anomaly user. By using the energy analysis graph as an input to the analysis model, it is possible to reflect the correlations between the plurality of the corporate users, making predicted gas anomaly users more accurate.

Some embodiments of the present disclosure provide a non-transitory computer-readable storage medium storing computer instructions. A computer performs the method for supervising the smart gas corporate user when the computer reads the computer instructions in the storage medium.

The embodiments in the present disclosure are for the purpose of exemplification and illustration only and do not limit the scope of application of the present disclosure. To those skilled in the art, various amendments and changes that may be made under the guidance of the present disclosure remain within the scope of the present disclosure.

Some features, structures, or characteristics of one or more embodiments of the present disclosure may be suitably combined.

Finally, it should be understood that the embodiments described in the present disclosure are used only to illustrate the principles of the embodiments of the present disclosure. Other deformations may also fall within the scope of the present disclosure. Therefore, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for supervising a smart gas corporate user, wherein the method is executed by an Internet of Things (IoT) system for supervising a smart gas corporate user, and the method comprises:
obtaining corporate user information of a corporate user in a target area based on a data storage center of a gas management platform; obtaining production status information of the corporate user based on a governmental supervision and management platform; and obtaining current gas data of the corporate user at a preset time period base on a gas metering instrumentation of a gas device object platform;
determining at least one of a production phase and a production energy efficiency of the corporate user based on the corporate user information, the production status information, and the current gas data;
generating a gas supervision parameter based on the production phase and the production energy efficiency, the gas regulatory parameter including at least one of a data monitoring frequency and a data uploading frequency of a monitoring device for a current production phase;
sending the gas supervision parameter to the monitoring device of the gas device object platform; and
monitoring gas data of the corporate user based on the data monitoring frequency and uploading the monitored gas data to the gas management platform at the data uploading frequency by the gas device object platform, and uploading the monitored gas data to the governmental supervision and management platform by the gas management platform.

2. The method of claim 1, wherein the determining at least one of a production phase and a production energy efficiency of the corporate user based on the corporate user information, the production status information, and the current gas data includes:
determining the production phase based on change data of the current gas data;
determining an energy efficiency calculation rule of the corporate user based on the corporate user information; and
determining the production energy efficiency based on the production status information, the current gas data, and the energy efficiency calculation rule.

3. The method of claim 2, wherein the monitoring device includes an exhaust gas monitoring device, and the determining the production energy efficiency based on the production status information, the current gas data, and the energy efficiency calculation rule includes:
determining an initial production energy efficiency based on the production status information and the current gas data using the energy efficiency calculation rule;
determining the exhaust gas monitoring device of the gas device object platform based on historical energy efficiency data of the corporate user;
obtaining exhaust gas data of the corporate user based on the exhaust gas monitoring device;
determining a combustion adequacy of the corporate user based on the exhaust gas data; and
determining the production energy efficiency based on the combustion adequacy and the initial production energy efficiency.

4. The method of claim 2, wherein the change data includes gas usage change data and usage duration change data, and the determining the production phase based on change data of the current gas data includes:
predicting future gas data based on the gas usage change data, the usage duration change data, and the current gas data;
plotting a gas profile based on the current gas data and the future gas data; and
determining the production phase based on the gas profile.

5. The method of claim 4, wherein the predicting future gas data based on the gas usage change data, the usage duration change data, and the current gas data includes:
determining a change characteristic based on the gas usage change data and the usage duration change data through a change characteristic layer of a gas usage model, the gas usage model being a machine learning model; and
determining the future gas data based on the current gas data and the change characteristic through a gas prediction layer of the gas usage model.

6. The method of claim 5, wherein an input of the gas prediction layer includes historical gas data and energy efficiency change information of a corporate classification.

7. The method of claim 1, wherein the generating a gas supervision parameter based on the production phase and the production energy efficiency includes:
obtaining a historical production phase and a historical production energy efficiency of the corporate user;
determining energy efficiency change information of at least one corporate classification based on historical production phase and historical production energy efficiency of a corporate user in the at least one corporate classification; and
for the corporate user in the at least one corporate classification, determining the gas supervision parameter of the corporate user based on the energy efficiency change information of the corporate classification, the production phase of the corporate user, and the production energy efficiency.

8. The method of claim 1, wherein the determining energy efficiency change information of at least one corporate classification based on historical production phase and historical production energy efficiency of a corporate user in the at least one corporate classification includes:
for one of the at least one corporate classification,
determining the energy efficiency change information of the corporate classification based on energy efficiency change information of the historical production energy efficiency of the corporate user in the corporate classification by a weighting calculation, wherein a weight of the weighting calculation is related to a duration of each production phase in the corporate classification.

9. The method of claim 8, wherein the weight is further related to a combustion adequacy of the corporate user in the corporate classification.

10. The method of claim 7, wherein the generating a gas regulatory parameter based on the production phase and the production energy efficiency includes:
determining a gas anomaly user based on at least one of the energy efficiency change information of the at least one corporate classification, the production phase, and the production energy efficiency; and
obtaining an adjusted gas regulatory parameter by adjusting a gas regulatory parameter of the gas anomaly user.

11. The method of claim 10, wherein the determining a gas anomaly user based on at least one of the energy efficiency change information of the at least one corporate classification, the production phase, and the production energy efficiency includes:
for one of the at least one corporate classification,
constructing an energy analysis graph based on the corporate user, a production phase and a production energy efficiency of the corporate user in the corporate classification, wherein the energy analysis graph includes nodes and edges, the nodes include the corporate user, and attributes of the nodes include production status information, a product type, a production device, the production energy efficiency, and the production phase of the corporate user; and the edges include a connecting line between any two of the nodes, and attributes of the edges include a similarity between two corporate users corresponding to the edges; and
determining the gas anomaly user by inputting the energy analysis graph into an analysis model, the analysis model being a machine learning model.

12. An Internet of Things (IoT) system for supervising a smart gas corporate user, wherein the IoT system includes a corporate user platform, a corporate user service platform, a gas management platform, a gas sensing network platform, and a gas device object platform interacting with each other, and the IoT system is configured to:
obtain corporate user information of a corporate user in a target area based on a data storage center of the gas management platform; obtain production status information of the corporate user based on a governmental supervision and management platform; and obtain current gas data of the corporate user at a preset time period base on a gas metering instrumentation of the gas device object platform;
determine at least one of a production phase and a production energy efficiency of the corporate user based on the corporate user information, the production status information, and the current gas data;
generate a gas supervision parameter based on the production phase and the production energy efficiency, the gas regulatory parameter including at least one of a data monitoring frequency and a data uploading frequency, of a monitoring device for a current production phase;
send the gas supervision parameter to the monitoring device of the gas device object platform; and
monitor gas data of the corporate user based on the data monitoring frequency and upload the monitored gas data to the gas management platform at the frequency of data by the gas device object platform, and upload the monitored gas data to the governmental supervision and management platform by the gas management platform.

13. The IoT system of claim 12, wherein the gas management platform includes a data processing center and a data storage center;
the IoT system further comprises a governmental supervision user platform and a governmental supervision service platform, the governmental supervision management platform, a governmental supervision sensor network platform, and a governmental supervision object platform; and
the gas management platform interacts with the governmental supervision sensor network platform.

14. The IoT system of claim 12, wherein the gas management platform is further configured to:
determine the production phase based on change data of the current gas data;
determine an energy efficiency calculation rule of the corporate user based on the corporate user information; and
determine the production energy efficiency based on the production status information, the current gas data. and the energy efficiency calculation rule.

15. The IoT system of claim 14, wherein the monitoring device includes an exhaust gas monitoring device, and the gas management platform is further configured to:
determine an initial production energy efficiency based on the production status information and the current gas data using the energy efficiency calculation rule;
determine the exhaust gas monitoring device of the gas device object platform based on historical energy efficiency data of the corporate user;
obtain exhaust gas data of the corporate user based on the exhaust gas monitoring device;
determine a combustion adequacy of the corporate user based on the exhaust gas data; and
determine the production energy efficiency based on the combustion adequacy and the initial production energy efficiency.

16. The IoT system of claim 14, wherein the change data includes gas usage change data and usage duration change data, and the gas management platform is further configured to:
predict future gas data based on the gas usage change data, the usage duration change data, and the current gas data;
plot a gas profile based on the current gas data and the future gas data; and
determine the production phase based on the gas profile.

17. The IoT system of claim 16, wherein the gas management platform is further configured to:
determine a change characteristic based on the gas usage change data and the usage duration change data through a change characteristic layer of a gas usage model, the gas usage model being a machine learning model; and
determine the future gas data based on the current gas data and the change characteristic through a gas prediction layer of the gas usage model.

18. The IoT system of claim 17, wherein an input of the gas prediction layer includes historical gas data and energy efficiency change information of a corporate classification.

19. The IoT system of claim 12, wherein the gas management platform is further configured to:
obtain a historical production phase and a historical production energy efficiency of the corporate user;
determine the energy efficiency change information of at least one corporate classification based on historical production phase and historical production energy efficiency of a corporate user in the at least one corporate classification; and
for the corporate user in the at least one corporate classification, determine the gas regulatory parameter of the corporate user based on the energy efficiency change information of the corporate classification, the production phase of the corporate user, and the production energy efficiency.

20. A non-transitory computer-readable storage medium storing computer instructions, wherein when a computer reads the computer instructions in the storage medium, the computer performs the method of claim 1.
